(19) United States
(12) Patent Application Publication
(10) Pub. No.: US 2026/0273917 A1
(43) Pub. Date: Sep. 17, 2026

(54) METHOD FOR CORRECTING A REGISTRATION DURING PROCESSING OF A WEB OF PRINTING SUBSTRATE

(71) Applicant: Heidelberger Druckmaschinen AG, Heidelberg (DE)

(72) Inventor: Werner Schwab, Bechtsrieth (DE)

(21) Appl. No.: 19/563,041

(22) Filed: Mar. 11, 2026

(30) Foreign Application Priority Data
Mar. 13, 2025 (DE) 10 2025 109 533.7

(51) Int. Cl. B41F 13/02; B41F 33/14

(52) U.S. Cl. CPC B41F 13/025; B41F 33/14

(57) ABSTRACT

A method for correcting a registration during the processing of a web of a printing substrate. A series of identical registration marks is printed onto the web by a rotating cylinder of a first printing unit. Then the registration marks are detected and a computer controls a registration actuator to correct the registration. For evaluating the series of registration marks, a dynamic lateral movement and/or dynamic lateral deformation of the web from one unit to a subsequent unit is determined computationally, and a dynamic lateral registration correction takes place in a further subsequent unit. The dynamic lateral movement and the dynamic lateral deformation of the web as well as the duration and/or the length and/or the characteristics of a further web section between the subsequent unit and the further subsequent unit are taken into account.

### CROSS-REFERENCE TO RELATED APPLICATION

This application claims the priority, under 35 U.S.C. § 119, of German Patent Application DE 10 2025 109 533.7, filed Mar. 13, 2025; the prior application is herewith incorporated by reference in its entirety.

### FIELD AND BACKGROUND OF THE INVENTION

The invention relates to a method for correcting a registration during the processing of a web of printing substrate.

The invention belongs to the technical field of the graphic industry, particularly in the area of operating a rotary printing machine for processing web-shaped printing substrate in printing and preferably also in postpress. In particular, the invention belongs to the subfield of controlling or regulating the machine or the drives and actuators thereof in order to increase print quality and productivity and/or to prevent or reduce malfunctions, particularly through the use of printed registration marks and automatic registration controllers.

In printing machines that process cardboard and print on it, for example in flexographic printing and/or gravure printing, unexpected registration deviations can occur and lead to cost-increasing waste, both in the color registration and in the die-cut registration as well if the printing machine includes a die-cutting unit. Such errors can worsen from one printing unit to the next on the printing machine.

Registration control systems for printing machines are known from the prior art which operate, for example, as follows: Registration marks are printed, and they are detected. Deviations are determined from the detected spacing changes in the image comparison of the registration marks with specified mark spacings, and these deviations are then fed to controllers whose control variables change the color registrations so that no color offset occurs between the printed colors. Representative examples are: Published patent application US 2009/020029 A1 and its counterpart European publication EP2014470A1; U.S. Pat. No. 7,555,985 B2 and its counterpart international publication WO 2004/048092A2; and German patent application DE 10 2009 005 820 A1.

A distinction is usually made between reference color control and predecessor or successor color control; in reference color control, a printing unit, preferably the first one, is selected as the printing unit of reference with whose printed mark the spacing changes of the subsequent units are compared, and control deviations are generated. In predecessor or successor color control, the distances measured between the marks of any two consecutive printing units are evaluated.

Moreover, web/cylinder control is known from the prior art in which the position of a mark is determined in relation to the angular position of the printing unit printing the mark. Due to the limited accuracy in capturing the angular position, web-cylinder control provides lower resolutions in measuring registration shifts than web/web control, in which the positions of the marks are evaluated in camera images.

Published patent application US 2019/002227 A1 and its counterpart German application DE 10 2015 122 430 A1 disclose a method of this generic type for controlling the processing of a material web using registration marks. There, as here, a printing machine that conveys and processes the web is operated with a number of successive units. A series of identical registration marks is printed in a first printing unit onto the web. The series of registration marks is automatically detected, a computer evaluates the detected series of registration marks, and at least one registration actuator is controlled by the computer for correcting the registration. In other words, this is a method for controlling and regulating the processing of a material web, in particular packaging material, which is passed by a processing device for the purpose of processing and bears registration marks. The system can include multicolor printing and, for example, die-cutting; so-called gate control can be used, a pre-control value can be determined and used, and an elongation or stretching of the material web can be detected.

Furthermore, registration control methods for processing a web are known from the prior art in which so-called feed-forward controllers or feed-forward control methods are used. U.S. Pat. No. 8,807,032 B2 represents one example.

Despite the known registration control methods, registration errors due to unpredictable web movements, especially perpendicular to the web transport direction, often cannot be corrected quickly and adequately.

Manufacturers of graphic products, however, such as printing companies with prepress, press, and postpress, have a constant desire for improved product quality while maintaining or even increasing production speed.

### SUMMARY OF THE INVENTION

It is therefore an object of the present invention to provide an improvement over the prior art which, in particular, makes it possible to detect and quickly and adequately correct registration errors due to unexpected web movements, particularly transverse to the web transport direction.

With the above and other objects in view there is provided, in accordance with the invention, a method for correcting a registration during the processing of a web of a printing substrate, the method comprising:
conveying and processing the web in a printing machine having a number of successive units;
printing a series of identical registration marks onto the web by a rotating cylinder of a first printing unit;
automatically detecting the series of registration marks in a subsequent unit following the first printing unit;
evaluating the series of registration marks by a computer and controlling at least one registration actuator by the computer for correcting the registration; and
for evaluating the series of registration marks, computationally determining at least one of a dynamic lateral movement of the web or a dynamic lateral deformation of the web occurring on a web section between the first printing unit and the subsequent unit; and
performing a dynamic lateral registration correction in a further subsequent unit, and calculating the dynamic lateral registration correction by taking into account at least one of a dynamic lateral movement or a dynamic lateral deformation of the web as well as at least one of a duration or a length or characteristics of a further web section between the subsequent unit and the further subsequent unit.

In other words, the method according to the invention deals with correcting a registration during the processing of a web of printing substrate. A web-feeding and web-processing printing machine is operated with a number N of successive units W(i). In a first printing unit W(a) at least a series of identical registration marks is printed onto the web by means of a rotating cylinder. The series of registration marks is automatically detected, a computer is operated for the purpose of evaluating the detected series of registration marks, and at least one registration actuator is controlled by the computer for the purpose of correcting the registration. According to the invention, the series of registration marks is detected in a subsequent unit W(b). During the evaluation of the series of registration marks, a dynamic lateral movement of the web and/or dynamic lateral deformation of the web occurring over the web travel distance S(a, b) between unit W(a) and subsequent unit W(b) is determined, and a dynamic lateral registration correction takes place in a further subsequent unit W(c). The dynamic lateral movement and/or dynamic lateral deformation of the web is incorporated into a computational adjustment corresponding to the duration and/or the length and/or to the characteristics of another web travel distance S(b, c) between subsequent unit W(b) and further subsequent unit W(c).

In terms of advantageous embodiments and effects, the invention advantageously enables the detection and rapid and adequate correction of registration errors due to unexpected web movements, especially perpendicular to the web transport direction. The invention is used, for example, in a flexographic printing machine with a die-cutting unit for printing industrial packaging.

One advantage of the invention is that the movement of the web, in particular an unexpected lateral movement, can be detected preferably with the aid of the first printed registration mark, e.g., the so-called zero mark of the reference color (first printed color used for so-called reference control), and that the movement of the web in the machine can be corrected computationally.

Advantageously, the detected position of the registration mark of the reference color in longitudinal and axial directions can be “frozen” at a specific time for computational comparison, i.e., stored, and the movement of the registration mark can be tracked computationally by comparison at each repeat (e.g., each circumferential rotation of the cylinder printing the registration mark).

If the reference color moves in the direction of web transport and/or transversely thereto, this movement is transmitted to the next printing unit or postpress unit via a so-called shift registration or with a corresponding motion vector representing the web movement, with precise timing (taking into account the time difference) and precise length (taking into account the length difference). This procedure is preferably carried out continuously, meaning that the measured movement of the reference color is transmitted continuously, advantageously in such a way that the web movement is compensated for before the registration deviation occurs. A higher-level registration control system continues to operate as usual. The registration control according to the invention therefore preferably constitutes an additional control especially for compensating for disturbing web movements using control technology.

In this specification, the term “dynamic” should be understood to mean that an adjustment takes place at least in time with each repeat. A repeat is a repetition of the registration mark, e.g., once or several times per cylinder revolution.

The following paragraphs describe preferred refinements of the invention. Specific features and embodiments may be combined with one another, unless the combination is not technically feasible.

In accordance with an added feature of the invention, the series of registration marks is detected in a subsequent unit W(b) and, during the evaluation of the series of registration marks, a dynamic longitudinal movement of the web and/or dynamic longitudinal deformation of the web occurring over the web travel distance S(a, b) between unit W(a) and subsequent unit W(b) is determined computationally, and, in a further subsequent unit W(c), a dynamic circumferential registration correction is carried out, in the calculation of which the dynamic longitudinal movement and/or dynamic longitudinal deformation of the web as well as the duration and/or the length and/or the characteristics of a further web travel distance S(b, c) between the subsequent unit W(b) and the further subsequent unit W(c) are taken into account.

In accordance with a further refinement of the invention, the dynamic lateral movement and/or the dynamic lateral deformation and/or the dynamic longitudinal movement and/or the dynamic longitudinal deformation of the web is generated computationally as a dynamic motion vector and made available to the subsequent unit W(c) for dynamic lateral registration correction and/or for dynamic circumferential registration correction. A provision can be made that the dynamic motion vector is generated as a multiplicity of dynamic motion vectors, each for a multiplicity of sections of the web. A provision can be made that the dynamic motion vector is supplied with precise timing. A provision can be made that the dynamic motion vector is made available to the subsequent unit W(c) at the time when the corresponding section of the web reaches the subsequent unit W(c).

In accordance with again a further refinement of the invention, the characteristics of the further web travel distance S(b, c) take into account the geometric web profile and/or the number of guide rollers and/or the respective positions of guide rollers and/or the respective circumferences of guide rollers. Dry sections and/or cooling sections on the web can also be included in the characteristics. The characteristics can mathematically represent the influence of the components (stretchers, guide rollers, dryers, cooling rollers) on the longitudinal and/or lateral movement and/or longitudinal and/or lateral deformation. For this purpose, test runs with corresponding measurements can be carried out beforehand and the data obtained can be stored; the test runs can be carried out with different printing substrates.

In accordance with yet a further refinement of the invention, the characteristics of the further web travel distance S(b, c) are generated computationally as a factor. A provision can be made that the dynamic motion vector is multiplied by the factor. A provision can be made that the duration and/or length of the further web travel distance S(b, c) is multiplied by the factor.

A further refinement can be characterized in that the detection of the series of registration marks in the subsequent unit W(b) is performed with a registration sensor or a registration camera.

Preferentially, the subsequent unit W(b) is a printing unit or a postpress unit. A provision can be made that the further subsequent unit W(c) is a printing unit or a postpress unit. The printing unit may be a flexographic printing unit, an intaglio printing unit, or a screen printing unit. The postpress unit may be a die-cutting unit with a flatbed die or with a rotary die. The postpress unit may be a finishing unit for cold foil finishing, hot foil finishing, embossing, blind embossing, cast-and-cure process, or lamination.

In a further refinement of the invention-with reference to the above-used parameters and indices: N≥3, N≥i≥1, a≥1, b>a, and N≥c>b.

In accordance with yet again a further feature of the invention, the X-direction is the local transport direction of the web. A provision can be made that the Y-direction is the local transverse direction in the web plane, perpendicular to the X-direction. A provision can be made that the dynamic longitudinal movement of the web and/or the dynamic longitudinal deformation of the web takes place in the Y-direction. A provision can be made that the dynamic lateral movement of the web and/or the dynamic lateral deformation of the web takes place in the Y-direction.

In a refinement, the printing machine processes a web of fiber-based material. The printing machine may process a web made of cardboard, paper, or a fiber-based composite material. Such webs tend to deform—e.g., to stretch —and thus necessitate registration corrections. Deformations of the web can be caused, for example, by guide rollers, dryers, and/or cooling rollers.

In yet a further preferred embodiment of the invention, the registration control is carried out by means of a registration mark camera that measures marks within a recorded image, or by means of a registration mark sensor that measures the passing marks at a known process speed. Certain registration marks are preferred, e.g., wedge marks, double wedge marks, block marks, dot marks, or other marks.

To describe a concrete example:

A rotary printing machine comprises six units W1 to W6. W1 does not print; W2 prints the reference color and thus the reference mark (registration mark); W3 does not print, and W4 prints; W5, an embossing unit, embosses, and W6, a die-cutting unit, die-cuts. With three processing units, the web movement can be measured using the first printed mark, the so-called reference mark. However, another printed mark can also be used.

The first printed mark is measured after printing, e.g., in a subsequent unit or en route to a subsequent unit, and provides information about the web movement, particularly in the direction transverse to the transport direction. This web movement is preferably measured at each unit using the registration sensors available there. Before the actual printing production, i.e., when the printing machine is starting up, the position of the mark is preferably stored upon its first detection and compared with the position of the next printed mark along the web. Generally, this is the next repeat —i.e., another pressure cylinder rotation —but it can be less, for example if there is more than one mark to be printed on one pressure cylinder circumference.

The movement of the marker is then corrected longitudinally and communicated to the next unit or units, for example via a corresponding motion vector. “Longitudinally corrected” means that the length of the web to the point in the next instrument where the registration correction takes place is taken into account. If a unit is not in use (e.g., W3), it can pass the vector information to the next unit (e.g., W4) again with longitudinal correction. However, it is better to remeasure the reference mark with the registration sensor in the unit W3 and pass on this longitudinally corrected value. The possible measured web movement in the unit W3 can then be transferred to the unit W4 as a vector. In other words, it is better to use the web movement from the unit W3 instead of the unit W2, because the latter represents the web movement more accurately. Preferably, measurements are always taken in one unit and the longitudinally corrected measurement is then forwarded to another unit, and so on.

The registration sensor in the second printing unit —i.e., in W4—measures the next mark, checks its registration, and simultaneously transmits the reference color movement, which depicts the web movement, via the vector to the next unit, i.e., unit W4.

The unit W5 is an embossing unit. The web movement from DW4 is forwarded to the embossing unit W5 with longitudinal correction, i.e., the longitudinal and lateral adjustment of the embossing unit are controlled in terms of their registration with the information from unit W4.

The information can then be forwarded to a die-cutting machine, the unit W6. Here, a web control system is preferably installed in order to compensate for errors in the lateral registration, meaning that the lateral registration can be pre-controlled via a web control unit, for example.

The technical features disclosed in the above text represent additional advantageous refinements of the invention as combinations of features that can be derived from this application. Other features which are considered as characteristic for the invention are set forth in the appended claims.

Although the invention is illustrated and described herein as embodied in a method for correcting a registration during processing of a web of printing substrate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic representation of a printing machine during the execution of a method according to the invention; and

FIG. 2 shows a schematic sectional view of the printing machine from FIG. 1 during the execution of the method according to the invention.

Like features and elements are identified with the same reference signs throughout the figures.

### DETAILED DESCRIPTION OF THE INVENTION

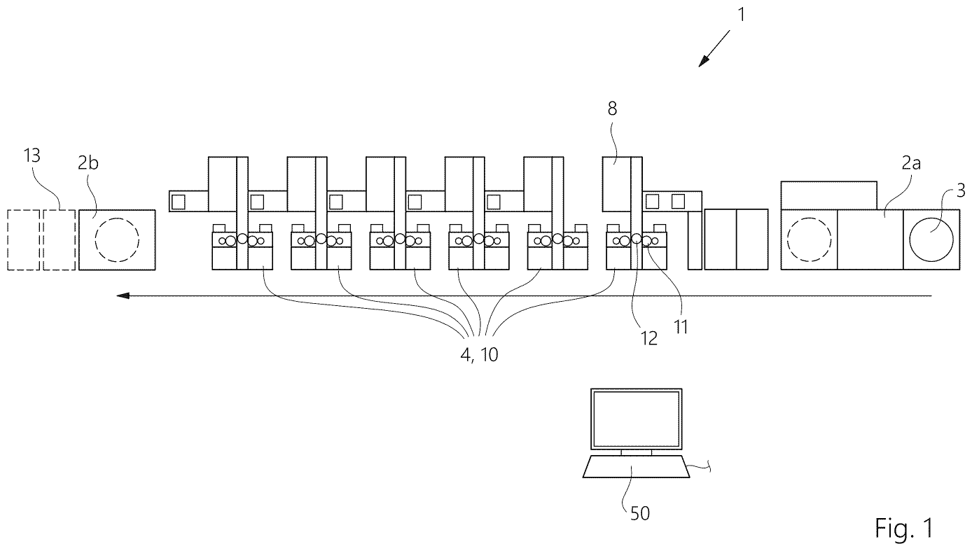

Referring now to the figures of the drawing in detail and first, in particular, to FIG. 1 thereof, there is shown printing machine 1, preferably a roll-to-roll rotary printing machine with an in-line configuration for flexographic printing of packaging. The printing machine 1 comprises an unwinder 2a for a roll 3 of a paper web and, optionally, a winder 2b for the printed paper web. Furthermore, the printing machine 1 comprises a plurality of units W(i) 4, in particular printing units 10, preferably flexographic printing units in the form of single or double printing units. The printing units, in turn, comprise printing cylinders 11 (also referred to as pressure cylinders 11) and impression cylinders 12 (also referred to as counterpressure cylinders 12). Furthermore, the printing machine 1 comprises a plurality of dryers 8, preferably hot air dryers, arranged in particular above the printing units. Finally, the printing machine 1 optionally comprises a postpress unit 13, in particular a die-cutting unit, as well as a digital computer 50 for controlling production, which is connected via links 51 to the units 4 for exchanging data or control signals.

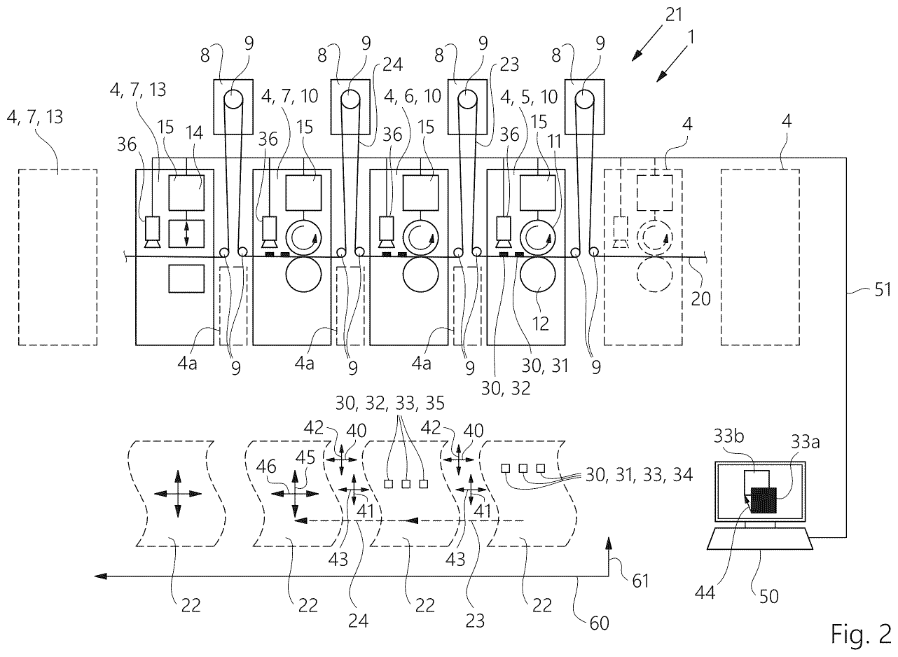

FIG. 2 shows the same printing machine 1 as FIG. 1, with features relevant to the invention shown schematically. The printing machine 1 can be seen in the upper part of FIG. 2; visible below it is a top view of web sections 22 of a web 20 that is being processed in the printing machine. The illustrated printing machine 1 executes a preferred embodiment of the method according to the invention during normal operation.

The printing machine 1 comprises a plurality of units W(i) 4; additional units 4a may optionally be arranged between these units 4 as intermediate units. The units 4 comprise at least the following: a first printing unit W(a) 5, a subsequent unit W(b), and a further subsequent unit W(c). Furthermore, the printing machine 1 comprises a plurality of dryers 8 and a multiplicity of guide rollers 9 for guiding the web 20 through the units 4 and the dryers 8. Units 4 which print the web 20 in the current print job to be processed are referred to as printing units 10; in these units 10, the web 20 passes through a respective gap between a rotating cylinder 11, preferably a printing cylinder, and another rotating cylinder 12, preferably a impression cylinder. Other components of the printing units 10, such as inking units or additional cylinders in the case of double printing units, have been omitted for purposes of illustration. Before the first printing unit 10, there may be further units 4 (shown as dashed lines) which are currently not in operation; the same may be the case following the last printing unit.

The printing machine 1 also optionally comprises a postpress unit 13, preferably a die-cutting unit, for example a flatbed die-cutting unit, with a tool 14, preferably a die-cutting tool that moves up and down, in which the printed web 20 is further processed.

The units 4 each comprise at least one registration actuator 15. The registration actuator 15 corrects the printing registration in the printing units 10, preferably the lateral registration and/or the circumferential registration (longitudinal registration), and a corresponding registration in the postpress units 13, for example the die-cut registration.

The web 20 has a web path 21 through the printing machine 1 and through the units 4 and over stretches between these units. The web path 21 is determined primarily by the arrangement of the units 4 to each other and the number and arrangement of the guide rollers 9. Sections 22 of the web 20, a web travel distance S(a, b) 23, and a further web travel distance S(b, c) 24 between the sections 22 are shown below the printing machine 1 for clarification.

The first printing unit 5 prints registration marks 30, at least one first registration mark 31 and at least one second registration mark 32, as a series 33 of registration marks, more particularly as a first series 34 of registration marks on the web 20. The registration marks can be identical and, for example, generated upon each revolution of the cylinder 11. The second printing unit, which is the subsequent unit 6 in the example shown, also prints registration marks 30, 31, and 32 and also as series 33 or 35.

Each of the units 4 comprises at least one device for detecting the registration marks on the web 20, preferably a registration sensor 36 or a registration camera 36 (hereinafter assumed by way of example to be a registration camera). The web 20 may experience dynamic deviations from an ideal path along the web path 21, for example in the form of unpredictable and undesirable, minor but nevertheless registration-disrupting movements or deformations, particularly elongations. These are shown in FIG. 2 as double arrows: dynamic transverse movement 40 of the web, dynamic transverse deformation 41 of the web, dynamic longitudinal movement 42 of the web, and dynamic longitudinal deformation 43 of the web, which can also overlap.

Such a disturbance between unit 5 and subsequent unit 6 can be determined computationally by means of the registration marks 30 printed in the unit 5 and by means of the registration camera 36 in the unit 5 and by means of the registration camera 36 in the subsequent unit 6. For this purpose, the digital computer 50 repeatedly compares a first image 30a of the registration mark 30 from unit 5 with a second image 30b of the same registration mark 30 from the subsequent unit 6 and computationally derives a dynamic motion vector 44 of the web 20 from this. The computer 50 transmits this motion vector 44 to the subsequent unit 7, taking into account in particular the length of the web travel distance 21 between the two units 6 and 7. The motion vector 44 is thus available in the subsequent unit 7 for a dynamic registration correction at the right moment, namely when the corresponding section 22 of the web 20 arrives in the subsequent unit 7. On the basis of the motion vector 44, a dynamic lateral correction 45 in the Y-direction 61 and/or a dynamic circumferential registration correction 46 in the X-direction 60 can be carried out in the subsequent unit 7 at the correct time or in the correct web section 22. A similar procedure can also be followed between further pairs/triplets of units 4, in which case postpress units 13 can also be taken into account in the registration control in addition to the printing units 10.
The following is a summary list of reference numerals and the corresponding structure used in the above description of the invention:
1 printing machine
2a unwinder
2b optional winder
3 roller
4 unit(s) W(i)
4a optional intermediate unit(s)
5 first printing unit W(a)
6 subsequent unit W(b)
7 further subsequent unit W(c)
8 dryer
9 guide roller(s)
10 printing unit
11 rotating cylinder, pressure cylinder
12 rotating cylinder, counterpressure cylinder
13 optional postpress unit
14 tool, e.g., die-cutting tool
15 registration actuator(s)
20 web
21 web path
22 section(s) of the web
23 web travel distance S(a, b)
24 further web travel distance S(b, c)
30 registration mark(s)
30a first image of the registration mark
30b second image of the registration mark
31 first registration mark
32 second registration mark
33 series of registration mark(s)
34 first series of registration mark(s)
35 second series of registration mark(s)
36 registration sensor or registration camera
40 dynamic lateral movement of the web
41 dynamic lateral deformation of the web
42 dynamic longitudinal movement of the web
43 dynamic longitudinal deformation of the web
44 dynamic motion vector of the web
45 dynamic lateral registration correction
46 dynamic circumferential registration correction
50 computer
51 link(s)
60 X-direction, transport direction of the web
61 Y-direction, transverse direction

1. A method for correcting a registration during the processing of a web of printing substrate, the method comprising:
conveying and processing the web in a printing machine having a number of successive units;
printing a series of identical registration marks onto the web by a rotating cylinder of a first printing unit;
automatically detecting the series of registration marks in a subsequent unit following the first printing unit;
evaluating the series of registration marks by a computer and controlling at least one registration actuator by the computer for correcting the registration; and
for evaluating the series of registration marks, computationally determining at least one of a dynamic lateral movement of the web or a dynamic lateral deformation of the web occurring on a web section between the first printing unit and the subsequent unit; and
performing a dynamic lateral registration correction in a further subsequent unit, and calculating the dynamic lateral registration correction by taking into account at least one of a dynamic lateral movement or a dynamic lateral deformation of the web as well as at least one of a duration or a length or characteristics of a further web section between the subsequent unit and the further subsequent unit.

2. The method according to claim 1, which comprises:
detecting the series of registration marks in the subsequent unit, and for evaluating the series of registration marks, computationally determining at least one of a dynamic longitudinal movement of the web or a dynamic longitudinal deformation of the web occurring over a web travel distance between the first unit and the subsequent unit; and
carrying out a dynamic circumferential registration correction in the further subsequent unit, and calculating the dynamic circumferential registration correction by taking into account at least one of a dynamic longitudinal movement or dynamic longitudinal deformation of the web as well as at least one of a duration or a length or characteristics of a further web travel distance between the subsequent unit and the further subsequent unit.

3. The method according to claim 2, which comprises:
computationally generating at least one of the dynamic transverse movement or the dynamic transverse deformation or the dynamic longitudinal movement or the dynamic longitudinal deformation of the web as a dynamic motion vector; and
providing the dynamic motion vector to the subsequent unit for dynamic lateral registration correction and/or dynamic circumferential registration correction.

4. The method according to claim 3, which comprises generating the dynamic motion vector as a multiplicity of dynamic motion vectors each for a multiplicity of sections of the web.

5. The method according to claim 3, which comprises providing the dynamic motion vector with precise timing.

6. The method according to claim 5, which comprises providing the dynamic motion vector to the subsequent unit at a time when the respective section of the web reaches the subsequent unit.

7. The method according to claim 1, which comprises:
computationally generating at least one of the dynamic transverse movement or the dynamic transverse deformation of the web as a dynamic motion vector; and
providing the dynamic motion vector to the subsequent unit for dynamic lateral registration correction.

8. The method according to claim 1, which comprises including in the characteristics of the further web travel distance at least one of a geometric web profile, a number of guide rollers, respective positions of guide rollers, or respective circumferences of guide rollers.

9. The method according to claim 8, which comprises computationally generating the characteristics of the further web travel distance as a factor.

10. The method according to claim 9, which comprises multiplying the dynamic motion vector by the factor.

11. The method according to claim 1, wherein the subsequent unit is a printing unit or a postpress unit and the further subsequent unit is a printing unit or a postpress unit.
